(19) United States
(12) Patent Application Publication
(10) Pub. No.: US 2026/0309660 A1
(43) Pub. Date: Oct. 8, 2026

(54) SYSTEM FOR DETECTING DEFECTS WITHIN A FLUID FLOWING THROUGH A CIRCUIT COMPRISING A FLUIDIC DEVICE, AND FOR PREVENTING FAILURE OF THE DEVICE AS A RESULT OF THE DEFECTS

(71) Applicant: COMMISSARIAT A L'ENERGIE ATOMIQUE ET AUX ENERGIES ALTERNATIVES, Paris (FR)

(72) Inventor: Mathieu DARNAJOU, PERTUIS (FR)

(21) Appl. No.: 19/108,366

(22) PCT Filed: Sep. 6, 2024
(86) PCT No.: PCT/EP2024/074956

§ 371 Date: Mar. 3, 2025

(30) Foreign Application Priority Data
Sep. 6, 2023 (FR) FR2309346

(51) Int. Cl. G01N 27/02; G05B 11/60

(52) U.S. Cl. CPC G01N 27/028; G05B 11/60

(57) ABSTRACT

System for detecting defects within a fluid flowing through a circuit having a fluidic device, and for preventing failure of the device as a result of the defects. A system for detecting one or more defects capable of causing failure, or even breakage, of a fluidic device installed in a fluidic circuit. The system includes an electrical sensor with electrodes distributed, preferably regularly, around a section upstream of the device and with their ends flush with the internal wall of the section. EIT measurements (EIT standing for Electrical Impedance Tomography) are carried out using signals, which are either trigonometric or applied via pairs of electrodes, and which are applied simultaneously to excite all the electrodes or sequentially to a sub-set of electrodes. This measurement makes it possible, in a non-invasive and non-destructive way, to view, in real time and continuously, the interior of the section and therefore the fluid flowing within it, by measuring electrical properties (electrical current and potential).

### TECHNICAL FIELD

The present invention relates to the field of monitoring fluidic devices intended to be employed in a fluidic circuit, and in particular in an industrial plant.

The invention more particularly relates to detection of a defect of any type capable of being present in a fluid flowing through a fluidic circuit and capable of causing failure or even breakage of a fluidic device in said circuit.

Although described with reference to an application to pump monitoring, the invention may be applied to monitoring of any type of fluidic device capable of being present in a fluidic circuit, and in particular in an industrial installation.

The term “fluidic device” is understood here and in the context of the invention to mean any component or set of mechanical or electromechanical components capable of being employed in a fluidic circuit. It may be a question of a device at least one rotary component of which displaces volumes of fluid continuously and/or discontinuously (pump) or that uses the force of a fluid (turbine). It may be a question of a device with a fixed or mobile component that modifies the flow of a fluid, such as a valve, a check valve, a piston, an elbow, or a gooseneck. It may also be a question of a duct of the fluidic circuit that has at least one unwanted leak. It may be a question of a fluidic duct running the risk of clogging, jamming or fouling. It may also be a question of an intrusive or non-intrusive fluid sensor for measuring at least one property of a fluid.

By “defect”, what is meant here and in the context of the invention is any anomaly present in a fluid flowing through a fluidic circuit that modifies the expected characteristics of the fluid (such as its temperature, pressure, flow rate, viscosity, or its monophasic behavior), i.e. the characteristics that it was initially intended to have. It may be a question of a foreign body suspended in a flowing fluid, such as a metal body (one or more residues of welding, a bolt, etc.). It may also be a question of one or more agglomerates of solid material, of fouling of a wall, of a jam due to solid particles, of clogging, or of formation of one or more plugs. It may also be a question of air bubbles due either to one or more leaks or to cavitation.

### PRIOR ART

Pumps are a key component of industrial plants, and, at the present time, after electric motors, are the second most manufactured device in the world.

Pumps transport the fluids necessary for human activities, especially industrial activities, such as most raw materials, water, the fluids of food production and processing, of the chemical industry, of the pharmaceutical industry, of the construction industry, of the paper-making industry, of the electronics industry, of the mining industry, of the petroleum industry, etc.

Malfunction, including breakage, of a pump may quickly lead to the shutdown of an entire factory, and thus generate very high production stoppage costs. The inventor has been able to quantify among manufacturers of one sector that about 5% of plants with new pumps were forced to shut down when first started up due to the presence of metal foreign bodies (such as residues of welding, bolts, etc.) ending up in the pumps and damaging their mechanism.

Furthermore, the causes of breakage of pumps are, first and foremost:
so-called cavitation effects, i.e. the presence of vapor bubbles created by too high a suction power or by the absence of fluid at the suction end of a pump,
the presence of foreign bodies,
jams due to solids.

To solve this problem, the pumps may be disassembled and parts replaced or cleaned as part of scheduled maintenance. However, this may result in unnecessary expense because, to be on the safe side, pumps must be serviced more frequently than is really necessary.

There are a high number of systems for monitoring fluidic circuits incorporating one or more pumps.

They are mainly based on measurement of pressure differences, vibrations, or measurement of infrared or ultrasound, as described in patent applications/patents FR3026443A1, CN111197581A and EP1297331B1, respectively.

These existing systems do not really anticipate pump breakdowns and/or accurately identify all the malfunctions that cause them.

In particular, implemented commercial solutions, which allow detection of a high degree of cavitation, do not measure the risks of foreign bodies in the fluid, jams or clogging.

There is therefore a need for a system for monitoring a pump in a fluidic circuit that overcomes the drawbacks of known systems, in particular in order to allow every type of defect liable to cause a pump to fail or even break, other than cavitation, to be detected.

More generally, there is a need for a system for monitoring a fluidic device employed in a fluidic circuit that is able to detect any type of defect capable of causing at least part of the device to fail or even break, and thus to prevent said failure.

One aim of the invention is to at least partially meet these needs.

### SUMMARY OF THE INVENTION

To this end, one subject of the invention, according to one of its aspects, is a system for detecting at least one defect liable to be present in a fluid flowing through a fluidic circuit comprising at least one fluidic device and, where appropriate, at least one fluidic bifurcation upstream of the fluidic device, and for preventing failure of the fluidic device inherent to the one or more defects, comprising:
at least one electrical sensor comprising a plurality of electrodes distributed around a section of the fluidic circuit upstream of the fluidic device, with their ends flush with the internal surface of the section;
an electronic circuit for controlling the electrodes and for taking electrical-impedance-tomography measurements, the circuit being configured to excite respective electrodes simultaneously, and to measure electrical impedance matrices of the fluid flowing through the section;
a signal-processing unit, configured to identify the one or more defects and/or to reconstruct images of the fluid flowing through the section, based on the measurements of impedance matrices of the electronic circuit;
an electronic unit for automatically controlling a controller of the fluidic device or the fluidic device itself or where appropriate the fluidic bifurcation, configured to, respectively, modify the frequency of operation of the fluidic device or control its operation or interrupt its operation so as to prevent failure of the fluidic device or to physically extract one or more defects upstream of the fluidic device, depending on signals of the flowing fluid representative of one or more defects.

According to one variant of embodiment, the fluidic device is a pump or a turbine, the controller being a variable frequency drive.

Advantageously, operation of the electronic unit for automatically controlling the fluidic device is subjugated to operation of the signal-processing unit.

According to one advantageous mode of construction, the system comprises a module to be arranged in the fluidic circuit, upstream of the fluidic device, the module comprising:
a duct defining the fluidic section,
a casing fastened around the duct, housing the electrical sensor with the electrodes individually housed and fastened in a seal-tight manner in a through-hole of the duct.

Preferably, the casing houses a port for supplying electrical power to the electrodes.

Also preferably, the duct comprises, at least at one of its ends, a flange for fastening to a duct of the fluidic circuit.

Such a module may thus be directly and easily implanted in an existing or new fluidic circuit.

It may therefore be used as a retrofit module of an existing circuit.

The module may also be integrated directly into the fluidic device (pump body, valve body, etc.).

According to one advantageous variant of embodiment, the signal-processing unit is configured to implement an image-reconstructing neural network.

According to one advantageous embodiment, the control circuit is configured to implement the following steps:
a/exciting the electrodes, each electrode being excited by a potential Vₙ^{exc} having either the form:

$${V}_{n}^{e x c} ( t ) = A {\sum }_{m = I}^{{n}_{e}} cos ( 2 π {f}_{m} t ) [ {δ}_{m}^{𝕆} cos ( {m θ}_{n} ) + {δ}_{m}^{𝔼} sin ( \frac{m {θ}_{n}}{2} ) ] \qquad [ Math 2 ]$$

where A is a signal amplitude, nₑ is the number of electrodes, θn is the angular position of electrode n, fₘ=m*f₀ is an oscillation frequency, f₀ is a fundamental frequency chosen such that fₘ is lower than the Nyquist frequency of the system for any m, [symbol] is the set of all odd natural numbers and [symbol] is the set of all even natural numbers,
or the form:

$${V}_{n}^{e x c} ( t ) = - {\sum }_{j = 1}^{n - 1} {[ {V}_{j} ( t ) ]}_{n - 1} + {\sum }_{l = {l}_{n}^{min}}^{{l}_{n}^{max}} {Ψ}_{l} ( t ) , \qquad [ Math 5 ]$$

in which, by convention, a sum is identically zero if the value of the start index is greater than the value of the end index,
in which:

$${Ψ}_{i} ( t ) = A sin ( 2 π {f}_{i} t ) , \qquad [ Math 6 ]$$

$${l}_{n}^{min} = ( n - 1 ) {n}_{e} - \frac{n ( n - 1 )}{2} + 1 , \qquad [ Math 7 ]$$

$$and$$

$${l}_{n}^{max} = n {n}_{e} - \frac{( n + 1 ) n}{2} , \qquad [ Math 8 ]$$

and where [Vⱼ(t)]ₙ₋₁ designates the (n−1)th element of the identity defining the voltage Vⱼ(t), under the convention according to which the terms ψᵢ are always arranged in increasing order of the indices i in such an identity, the excitation being carried out either simultaneously on all the electrodes according to [Math 5] or sequentially on one or more sub-sets of electrodes;
b/measuring the electrical properties Vₙ^{meas} of flow of the fluid with the electrodes,
c/processing the data generated in measuring step b/, this comprising the following sub-steps:
c1/for each electrode Eₙ, computing data points Mₙ defined by:

$${M}_{n} ( k ) = \frac{1}{R P} \vert {\sum }_{p = 0}^{P - 1} {V}_{n}^{m e a s} ( p ) {e}^{i k {β}_{p}} \vert \qquad [ Math 10 ]$$

where R is the resistance of the resistor used to measure Vₙ^{meas} with

$${V}_{n}^{m e a s} = R {I}_{n}$$

across the terminals of the resistor, P is the number of points in a discrete sequence of measurements of the current Iₙ, p is the discrete time, k is a Fourier coefficient between 1 and (nₑ−1) and βₚ=(2πp/P),
c2/forming a data matrix D from the data points Mₙ(k) for all n and all k, according to the equation:

$$D = ( \begin{matrix}\{ {M}_{n} ( 1 ) \} \\ \{ {M}_{n} ( 2 ) \} \\ \{ {M}_{n} ( 3 ) \} \\ ⋮ \\ \{ {M}_{n} ( {n}_{e} - 1 ) \}\end{matrix} ) . \qquad [ Math 13 ]$$

if excitation form [Math 2] is employed,
or

$$D = ( \begin{matrix}\{ {M}_{n} ( 1 ) \} \\ \{ {M}_{n} ( 2 ) \} \\ \{ {M}_{n} ( 3 ) \} \\ ⋮ \\ \{ {M}_{n} ( \frac{{n}_{e} ( {n}_{e} - 1 )}{2} ) \}\end{matrix} ) , \qquad [ Math 14 ]$$

if excitation form [Math 5] is employed,
c3/forming a signed data matrix the elements of which are defined by the following equation when the phase shift Φ_{n,1}(k) between the excitation potential of electrode 1 and the measured current of electrode n is less than π/2:

$${D}_{n}^{m} = \frac{sin ( {Φ}_{n , l} ( k ) )}{\vert sin ( {Φ}_{n , l} ( k ) ) \vert} {D}_{n}^{m} . \qquad [ Math 20 ]$$

and the elements of which are defined by the following equation when the phase shift Φ_{n,1}(k) between the excitation potential of electrode 1 and the measured current of electrode n is greater than or equal to π/2:

$${\tilde{D}}_{n}^{m} = {\sum }_{n}^{m} {D}_{n}^{m} . \qquad [ Math 22 ]$$

where Σ is a sign matrix defined such that:
   if excitation form [Math 2] is employed, the i-th element of the j-th row of Σ is the sign of cos([2π/([j+1]/2)]*(i−1)/nₑ) for odd j and the sign of sine([2π/(j/2)]*(i−1)/nₑ) for even j,
   if excitation form [Math 5] is employed, the opposite sign is assigned to the nearest excitation electrode, in particular for a measurement electrode located equidistant between two excitation electrodes, the amplitude is experimentally measured to be of the order of O(10−7)A, corresponding to a negligible contribution to the data.

Preferably, the control circuit is configured to implement step a/with all of the potentials Vₙ^{exc} meeting the condition:

$${\sum }_{n = 1}^{{n}_{e}} {V}_{n}^{e x c} ( t ) = 0 . \qquad [ Math 4 ]$$

According to one advantageous configuration, the electrodes of the electrical sensor are regularly angularly distributed around the section of the fluidic circuit upstream of the pump. Another subject of the invention is the use of the detecting and preventing system such as described above to measure foreign bodies and/or to measure jams, clogging and/or fouling induced by the foreign bodies, cavitation, air bubbles, the absence of fluid and the presence of gas.

Another subject of the invention is an industrial plant, comprising at least a fluidic circuit and a detecting and preventing system such as described above.

Generally, the invention may be implemented in any fluidic circuit, in particular in a factory or on a site of industrial production, particularly in the fields of food processing and production, of pharmaceuticals and cosmetics, of chemistry and petrochemistry, and of water distribution and treatment.

The invention therefore essentially consists of a system for detecting one or more defects capable of causing failure, or even breakage, of a fluidic device installed in a fluidic circuit. The system comprises an electrical sensor with electrodes distributed, preferably regularly, around a section upstream of the device and with their ends flush with the internal wall of the section.

EIT measurements (EIT standing for Electrical Impedance Tomography) are carried out using signals, which are either trigonometric or applied via pairs of electrodes, and which are applied simultaneously to excite all the electrodes or sequentially to a sub-set of electrodes.

This measurement makes it possible, in a non-invasive and non-destructive way, to view, in real time and continuously, the interior of the section and therefore the fluid flowing within it, by measuring electrical properties (electrical current and potential).

The flow through the pipe is analyzed either directly via the measured signals or by reconstructing a map of the electrical impedance inside the section, by solving the inverse problem.

The rate of acquisition of the images reconstructed by the processing unit may be very high, typically up to 31 250 images/second, this making it possible to observe fluids flowing at a rate of up to 300 meters/second.

Depending on the signals of the flowing fluid representative of one or more defects, an electronic unit will automatically control either a controller of the fluidic device or the fluidic device itself or, where appropriate, an upstream fluidic bifurcation.

This unit therefore makes it possible to modify the operating frequency of the fluidic device, control its operation or interrupt its operation so as to prevent failures of the fluidic device or to physically extract one or more defects upstream of the fluidic device, respectively.

The invention that has just been described has many advantages, among which mention may be made of:
a measurement that is non-intrusive with respect to the fluid, creating no drop in pressure or accumulation of fouling;
a direct measurement of a defect causing failure or even breakage of a fluidic device;
a high speed of detection and of possible preventive action due to the ability to acquire measurements/images at a very high rate, up to 31 250 images/second;
a robust system because reliable regardless of the fluid used even under very high pressure (typically up to 300 bar or above) and/or at very high temperatures (typically up to 600° C. or above);
the ability to detect with the same system any type of defect, such as foreign bodies, jams, fouling, clogging, air bubbles due to leaks or cavitation, unlike prior-art systems configured to detect only one type of defect.

### BRIEF DESCRIPTION OF THE DRAWINGS

FIG. 1 illustrates a fluidic circuit comprising a pump, in which a flowing fluid capable of having a defect may be detected by a system for detecting and preventing pump failure according to the invention, comprising an electrical sensor with electrodes for electrical-impedance-tomography measurement.

FIG. 2 schematically illustrates the hardware and software means of a system for detecting and preventing pump failure according to the invention.

FIG. 3 illustrates a module incorporating an electrical sensor of a system according to the invention, which may be installed directly in a new or already existing fluidic circuit.

FIG. 3A is a cross-sectional view of a module according to FIG. 3, the cross section being cut through the electrodes of the electrical sensor.

FIG. 4 illustrates spatial cosine patterns.

FIG. 5 shows one portion of an electronic circuit allowing an electrode to be excited.

FIG. 6 illustrates a method for generating signals for exciting the electrodes of the electrical sensor according to a first variant of the invention.

FIG. 7 illustrates a method for measuring the signals generated by the electrodes.

FIG. 8 shows in graph form excitation signals of [Math 2] form and certain of their properties.

FIG. 9 illustrates a sign matrix for a 16-electrode electrical sensor relating to excitation of [Math 2] form.

FIG. 10 illustrates a sign matrix for a 32-electrode electrical sensor relating to excitation of [Math 2] form.

FIG. 11 illustrates images reconstructed according to the prior art and experimentally and simulated by a neural network in a system according to the invention, respectively.

### DETAILED DESCRIPTION

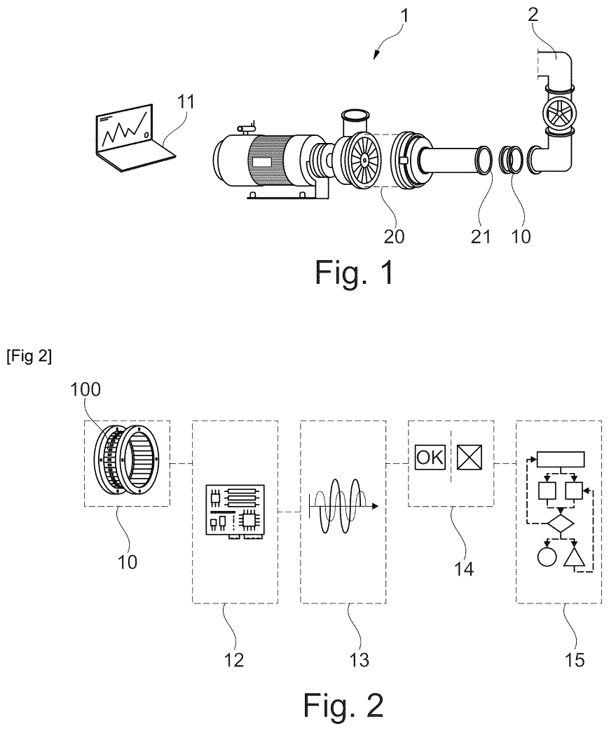

FIG. 1 illustrates one example of implementation of a system 1 for detecting defects within a fluid flowing through a circuit 2 comprising a pump 20. This system further makes it possible to prevent failure of the pump 2, as a result of defects according to the invention.

The defects may be of any type, such as foreign bodies (especially metal foreign bodies), jams, clogging, or air bubbles due to cavitation or leaks.

The system 1 firstly comprises an electrical sensor 10 arranged in a section of the circuit 2 upstream of the pump 2. This electrical sensor 10 makes it possible to perform electrical-impedance-tomography measurements on the fluid flowing through this section.

A unit 11 allows operational control of the variable frequency drive of the pump, according to real-time defect measurements, so as to prevent failure of the pump 20, depending on the signals of the flowing fluid representative of one or more defects, as detailed below.

More precisely, the electrical sensor 10 comprises electrodes 100 that are angularly distributed, in a regular or irregular manner, around the section 21 with their ends flush with the internal surface of the section 21.

The block diagram of the hardware and software means of the system 1 is illustrated in FIG. 2.

The electrodes 100 are connected to a printed circuit board 12, the printed circuit of which is an electronic circuit for controlling the electrodes 100 and for taking electrical-impedance-tomography measurements, the circuit being configured to excite respective electrodes simultaneously, and to measure electrical impedance matrices of the fluid flowing through the section 21.

A signal-processing unit 13 makes it possible to identify the one or more defects and/or to reconstruct images of the fluid flowing through the section 21, based on the measurements of impedance matrices of the electronic circuit 12.

An automatic electronic control unit 14 makes it possible, based on a risk 13 identified or not for the pump 20, preferably via digital communication, to control the variable frequency drive of the pump, and more generally to supervise the industrial plant in which the fluidic circuit 2 is installed.

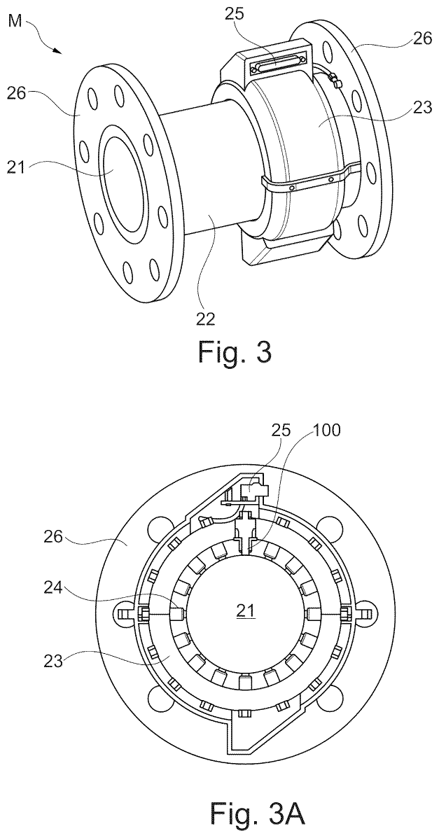

FIGS. 3 and 3A illustrate one advantageous mode of incorporation, in the form of a module M, of an electrical sensor 10 within a fluidic circuit.

The module M firstly comprises a duct 22 defining the fluidic section 21.

A casing 23 fastened around the duct 22 houses the electrical sensor 10 with the electrodes 100 individually housed and fastened in a seal-tight manner in a through-hole 24 of the duct.

The casing 23 may house a port 25 for supplying electrical power to the electrodes.

In order to easily and quickly incorporate and fasten the module M to a fluidic circuit, the duct 22 comprises at its two ends a flange 26 for fastening to a duct of the fluidic circuit.

The control circuit 12 may be connected to a data-acquiring system. A screen 11 may make it possible to view the data and images produced from these data. The data-acquiring system contains a Linux operating system (HOST) that controls an FPGA, also contained in the data-acquiring system. The FPGA may be replaced by a microcontroller.

The acquiring system makes it possible to generate the analog excitation signals and to measure the analog measurement signals delivered by the electrodes 2.

The acquiring system may for example incorporate a cRIO-9039 controller from the manufacturer National Instruments, which includes an FPGA, NI-9262 modules from the manufacturer National Instruments for generating analog excitation signals and NI-9223 modules from the manufacturer National Instruments for measuring analog signals delivered by the electrodes 100.

The method of measuring and processing the signals implemented by the system for detecting defects and preventing failure of the pump according to the invention will now be described.

It will be noted that the electrical sensor 10 is installed beforehand within the fluidic circuit with the electrodes 100 arranged as indicated above.

### Exciting the Electrodes

A first step consists in simultaneously exciting all the electrodes 100 with a potential having a well-chosen form.

The electrodes 100 form a set of linearly independent electrodes. They are used to create electrical excitations on the surface of the body and to measure electrical properties thereof.

The excitation according to the trigonometric template variant [Math 2] is as follows: for a number nₑ of electrodes there are (nₑ−1) linearly independent excitation patterns. Fourier basis functions are a natural choice to describe these linearly independent patterns, according to the equation:

$$\frac{1}{\sqrt{2 π}} {e}^{in θ} \qquad [ Math 1 ]$$

According to a first alternative, all of the electrodes are excited simultaneously using excitations of trigonometric form.

This set of simultaneous excitations is decomposed into spatial oscillations in the Fourier basis and into temporal oscillations.

Various frequencies are employed in order to establish a distinction between the various frequency-multiplexed trigonometric signals.

For each trigonometric excitation pattern, each electrode Eₙ is associated with one static voltage Vₙ^{sta}.

The set of nₑ static voltages Vₙ^{sta} forms a set of sinusoidal and cosinusoidal functions having various spatial frequencies m.

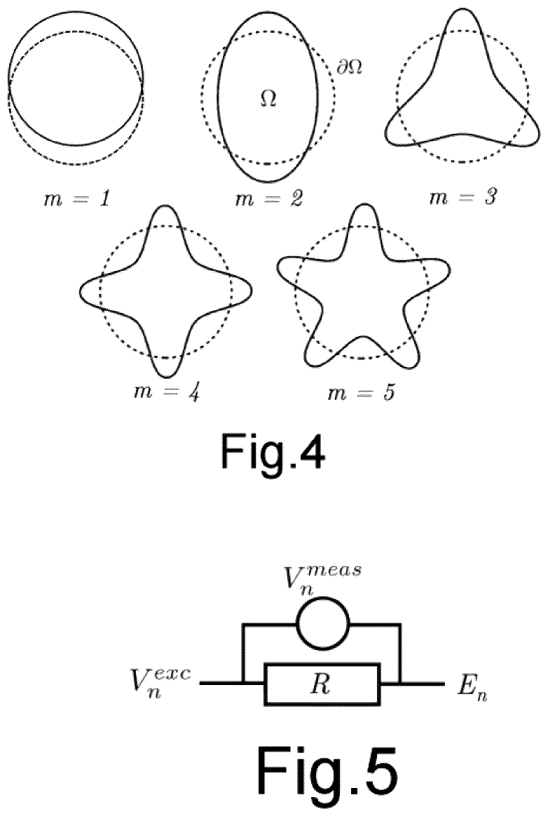

FIG. 4 shows the cosinusoidal spatial patterns for m varying from 1 to 5. The sinusoidal patterns have not been shown.

The nₑ electrodes are arranged on the body's periphery ∂Ω, which has been represented by dotted lines in FIG. 4. The solid lines represent the excitation potential applied to the electrodes.

The static potential V_{n,m}^{sta} associated with each electrode Eₙ is defined by the following equation, for n between 1 and nₑ:

$${V}_{n}^{e x c} ( t ) = A {\sum }_{m = I}^{{n}_{e}} cos ( 2 π {f}_{m} t ) [ {δ}_{m}^{𝕆} cos ( m {θ}_{n} ) + {δ}_{m}^{𝔼} sin ( \frac{m {θ}_{n}}{2} ) ] \qquad [ Math 2 ]$$

where A is a signal amplitude, m∈1, . . . , (n_e−1) represents the spatial frequency, nₑ is the number of electrodes, θₙ is the angular position of electrode n, fₘ=m*f₀ is an oscillation frequency, f₀ is a fundamental frequency chosen such that fₘ is lower than the Nyquist frequency of the system for any m, [symbol] is the set of all odd natural numbers and [symbol] is the set of all even natural numbers.

For a given set of nₑ electrodes, all the independent excitation patterns are fully described with (nₑ−1) different spatial frequencies. For the particular case where θₙ=2π n/nₑ, the electrodes are regularly distributed over the periphery of the body.

Each spatial frequency m is associated with a temporal frequency fₘ and is applied simultaneously to each of the electrodes.

Thus, each simultaneous excitation potential Vₙ^{exc} comprises a superposition of (nₑ−1) trigonometric functions, each function oscillating at a particular frequency fₘ.

The excitation signal of an electrode n is Vₙ^{exc}, as defined by the following equation:

$${V}_{n}^{e x c} ( t ) = {\sum }_{m = 1}^{{n}_{e}} cos ( 2 π {f}_{m} t ) {V}_{n , m}^{sta} = A {\sum }_{m = I}^{{n}_{e}} cos ( 2 π {f}_{m} t ) [ {δ}_{m}^{𝕆} cos ( m {θ}_{n} ) + {δ}_{m}^{1 E} sin ( \frac{m {θ}_{n}}{2} ) ] . \qquad [ Math 3 ]$$

Each potential Vₙ^{exc}(t) thus defined is simultaneously applied to each electrode Eₙ. Care is taken to ensure that the sum of the excitation voltages of the nₑ electrodes is zero whatever the time t. This is expressed by the condition:

$${\sum }_{n = 1}^{{n}_{e}} {V}_{n}^{e x c} ( t ) = 0 . \qquad [ Math 4 ]$$

According to a second alternative of the invention, the excitation form is as follows:

$${V}_{n}^{e x c} ( t ) = - {\sum }_{j = 1}^{n - 1} {[ {V}_{j} ( t ) ]}_{n - 1} + {\sum }_{l = {l}_{n}^{min}}^{{l}_{n}^{max}} {Ψ}_{l} ( t ) , \qquad [ Math 5 ]$$

in which, by convention, a sum is identically zero if the value of the start index is greater than the value of the end index,
where:

$${Ψ}_{i} ( t ) = A sin ( 2 π {f}_{i} t ) , \qquad [ Math 6 ]$$

$${l}_{n}^{min} = ( n - 1 ) {n}_{e} - \frac{n ( n - 1 )}{2} + 1 , \qquad [ Math 7 ]$$

$$and$$

$${l}_{n}^{max} = n {n}_{e} - \frac{( n + 1 ) n}{2} , \qquad [ Math 8 ]$$

and with [Vⱼ(t)]ₙ₋₁ designating the (n−1)th element of the identity defining the voltage Vⱼ(t), under the convention according to which the terms ψᵢ are always arranged in increasing order of the indices i in such an identity. The excitation may be carried out simultaneously on all the electrodes or sequentially on one or more sub-sets of electrodes.

### Measuring Electrical Properties

The electrical properties of the fluid flowing through the section 21 are then measured using the electrodes 100.

The unit 12 controls the FPGA of the acquiring system so as to generate 16 excitation signals having the described properties. These 16 digital signals are converted into analog signals by the NI-9262 modules and transmitted by coaxial cables to the electrodes 100.

The printed circuit board 12 comprises one exciting circuit for each electrode 100, each of these circuits comprising a resistor R as illustrated in FIG. 5. As may be seen in this figure, the potential Vₙ^{exc} is applied to one side of the resistor R, the other side being connected to the electrode Eₙ.

The Neumann boundary condition at electrode Eₙ is the current Iₙ passing through the exciting circuit. This current is obtained by measuring the voltage

$${V}_{n}^{meas} = R {I}_{n}$$

across the terminals of the resistor. As for Vₙ^{exc}, this signal is a sum of trigonometric functions.

### Processing the Data

In a fourth step, the data measured in the second step are processed in order either to deliver information directly to a processing algorithm, or to obtain a signed data matrix representative of an image.

### Generating Data Points Mₙ

In a first sub-step of the fourth step of the measuring method, the data points Mₙ are computed for each electrode n.

The Fourier transform of the measured signal Vₙ^{meas} is computed from a P-point current measurement sequence Iₙ(p), where p is the discrete time and respects 0≤p≤P, i.e.:

### [Math 9]

$${X}_{n} ( k ) = ℱ [ {I}_{n} ( p ) ] = \frac{θ}{R} {\sum }_{p = 0}^{P - 1} {V}_{n}^{m e a s} ( p ) {e}^{i k {β}_{p}}$$

where

$${β}_{p} = \frac{2 π p}{P} , i = \sqrt{- 1}$$

and the normalization factor

$$θ = \frac{1}{P} .$$

The Fourier transform may be computed at the frequency f₁ which corresponds to the frequency at which P Fourier coefficients are computed.

The frequencies fₘ of the voltages Vₙ^{exc} are chosen to be harmonics of f₁. This makes it possible to distinguish between the measured signals. Thus, each coefficient k is associated with one particular frequency fₘ.

The data are thus generated at a frequency f₁ and the resolution in Fourier space is Δf=fₘ₊₁−fₘ=f₁. It should be noted that the highest frequency is chosen to be lower than the Nyquist frequency of the system f_{Nyq}=½Δp, where Δp is the sampling time.

The data points Mₙ (k) are the moduli of each Fourier coefficient k for each electrode n:

$${M}_{n} ( k ) = \frac{1}{R P} \vert {\sum }_{p = 0}^{P - 1} {V}_{n}^{m e a s} ( p ) {e}^{ik {β}_{p}} \vert \qquad [ Math 10 ]$$

where R is the resistance of the resistor used to measure Vₙ^{meas} with

$${V}_{n}^{meas} = R {I}_{n}$$

across the terminals of the resistor, P is the number of points in a discrete sequence of measurements of the current Iₙ, p is the discrete time, k is a Fourier coefficient between 1 and (nₑ−1) and βₚ=(2πp/P),

Each data point defines the current of a given trigonometric pattern at a given electrode. The set of data points Mₙ(k) for all n and all k forms the measurement data.

The excitation frequencies are determined in the following way. The sampling frequency f_{DAQ} of the data-acquiring system limits the maximum frequency fₘ of the voltages Vₙ^{exec}, the Nyquist frequency f_{Nyq}=f_{DAQ}/2 being an upper limit.

For a data-acquiring system such that f_{DAQ}=1 MS/s, the Nyquist frequency is equal to 500 kHz.

To avoid small residual-voltage errors resulting from energy stored in the electrode-electrolyte contact impedance, continuous signals must be delivered. To generate continuous signals at various frequencies, the signals are chosen to be harmonics of the lowest generated frequency f₁.

When application of potential to an electrode is stopped, some of the electrical energy is stored for a few tens of microseconds at the interface between the electrode and the medium. This contact-impedance effect leads to an error in the measurement and implies the need to introduce a dead time between two successive excitations, to allow this energy to dissipate. Generation of continuous signals has the advantage of meaning that the applied voltages never stop, and therefore of avoiding errors related to contact impedance and the need to introduce dead times.

With a number of 16 electrodes, a set of excitation signals at 15 different frequencies (according to [Math 2]) or 120 different frequencies (according to [Math 5]) is generated. Given the sampling rate of the acquiring system, for example 1 MS/s, the frequencies may be chosen such that fᵢ=i*f₀ where f₀ is the fundamental frequency and i is between 1 and 15 or 1 and 120, respectively.

Furthermore, in the case with 15 frequencies, the discrete Fourier transforms may be performed at P=32 points because only positive results are considered. This results in a rate of acquisition of image data of 1*10⁶/32=31 250 images per second. This choice means that the lowest sinusoidal-signal frequency f₁ is equal to the frequency of computation of the discrete Fourier transforms and that the highest frequency f₁₅=15*f₀=468.875 kHz, which is below the Nyquist limit of 500 kHz for the system in question.

The excitation amplitudes are determined in the following way.

The voltage generation and the acquiring modules operate in an interval of +10 V. Considering the voltages Vₙ^{exc}, the amplitude A of the sinusoids will necessarily be significantly lower than the sum of the sinusoids generated as a result of constructive interference. However, the amplitude A of the signal must be as large as possible to minimize the signal-to-noise ratio.

Another limit to take into consideration is the permitted maximum variation between two successively generated potentials. Real-time control in the acquiring system makes it possible to choose a satisfactory value of A=0.15 V, which gives resonant peaks of ±2.25 V. The rapid transition between positive and negative values of the signal prevents the appearance of electrolytic effects. For example, an electrolysis-related effect appears in water when a DC voltage greater than 1.2 V is applied. This effect does not appear at AC voltages greater than 1.2 V if these voltages vary rapidly enough.

### Obtaining a Data Matrix D

In a second sub-step, a data matrix D is obtained from the data points Mₙ.

For the 16-electrode system in question, which employs NI-9223 modules, a fixed-point data format of 20 number-allocated bits, including 5 bits for precision digits, may be used. The index n of the electrodes, which is between 1 and 16, and the Fourier coefficient k, which is between 1 and 15, may be described by binary numbers coded on 4 bits.

For a 32-electrode system, each data-point modulus Mₙ(k) is coded with the numbers n and k in the following form:

$${M}_{n} ( k ) = {\underbrace{〈 + , 8 , 0 〉}}_{k} + {\underbrace{〈 + , 8 , 0 〉}}_{n} + {\underbrace{〈 \pm , 16 , 11 〉}}_{m} , \qquad [ Math 11 ]$$

where the fixed-point format <s, b, p> is used with s: signed/unsigned; b: number of bits allocated; p: number of precision bits. The data Mₙ(k) are encoded in U32 format.

The nₑ data points measured on the nₑ electrodes for a given Fourier coefficient k, i.e. for a given frequency fₘ, give the following data vector:

$$\{ {M}_{n} ( k ) \} = ( {M}_{1} ( k ) {M}_{2} ( k ) {M}_{3} ( k ) … {M}_{{n}_{e}} ( k ) ) \qquad [ Math 12 ]$$

where the Mₙ(k) are integers encoded in U32 format.

The nₑ−1 vectors may be concatenated into a data matrix D:

$$D = ( \begin{matrix}\{ {M}_{n} ( 1 ) \} \\ \{ {M}_{n} ( 2 ) \} \\ \{ {M}_{n} ( 3 ) \} \\ ⋮ \\ \{ {M}_{n} ( {n}_{e} - 1 ) \}\end{matrix} ) \qquad [ Math 13 ]$$

if excitation form [Math 2] is employed,
or

$$D = ( \begin{matrix}\{ {M}_{n} ( 1 ) \} \\ \{ {M}_{n} ( 2 ) \} \\ \{ {M}_{n} ( 3 ) \} \\ ⋮ \\ \{ {M}_{n} ( \frac{{n}_{e} ( {n}_{e} - 1 )}{2} ) \}\end{matrix} ) \qquad [ Math 14 ]$$

if excitation form [Math 5] is employed.

The size of the data is then S=nₑ(nₑ−1).

Only the moduli of the Fourier transforms form part of the data.

For an image, the data size is S*32 bits=4 kB. In comparison, the method described in publications [2], [3] and [4] results in 127 kB of data per image, without additional information on the boundary conditions.

Thus, the measuring method implemented by the system according to the invention allows a higher image acquisition rate and also allows the size of the data to be reduced by a factor nₑ/2 with respect to the method described in publications [2], [3] and [4].

### Obtaining a Signed Data Matrix

In a third sub-step, a signed data matrix representative of an image is obtained.

The Fourier transforms yield a modulus and a phase. The sign of each data point is estimated from the phase.

Thus, considering an excitation signal applied to each electrode Eₙ at a frequency fₘ having the form:

$${V}_{n , m}^{e x c} ( t ) = A cos ( 2 π {f}_{m} t ) [ {δ}_{m}^{𝕆} cos ( m {θ}_{n} ) + {δ}_{m}^{𝔼} sin ( \frac{m {θ}_{n}}{2} ) ] , \qquad [ Math 15 ]$$

the phase of the signal is expressed:

$${ϕ}_{n}^{V} ( k ) = arctan ( \frac{- {\sum }_{p = 0}^{P - 1} {V}_{n , m}^{m e a s} ( p ) sin ( k {β}_{p} )}{{\sum }_{p = 0}^{P - 1} {V}_{n , m}^{m e a s} ( p ) cos ( k {β}_{p} )} ) . \qquad [ Math 16 ]$$

The phase of the current Iₗ^{meas}(t) measured at the electrode Eₗ at the frequency fₘ is:

$${ϕ}_{l}^{I} ( k ) = arctan ( \frac{- {\sum }_{p = 0}^{P - 1} {I}_{l}^{m e a s} ( p ) sin ( k {β}_{p} )}{{\sum }_{p = 0}^{P - 1} {I}_{l}^{m e a s} ( p ) cos ( k {β}_{p} )} ) . \qquad [ Math 17 ]$$

Assuming synchronous sampling of the input of the analog signal AI and the output of the sampled signal AO, the phase shift between the excitation potential and the measured current is:

$${Φ}_{n , l} ( k ) = {ϕ}_{n}^{I} ( k ) - {ϕ}_{l}^{V} ( k ) . \qquad [ Math 18 ]$$

The phase shift depends on the design of the EIT sensors and on the nature of the flow within the body. If the phase shift is large, wrap-around effects may make reconstruction of the sign of the data impossible. Specifically, the phase is symmetric to a transformation of 2πN, where N is an integer. If the phase is greater than 2, it wraps around on itself.

The following two cases have been identified:

$$\vert {Φ}_{n , l} ( k ) \vert < \frac{π}{2} and \vert {Φ}_{n , l} ( k ) \vert \geq π / 2. \qquad [ Math 19 ]$$

In the first case, the sign of the data points is computed using the preceding equation. The element of the signed data matrix corresponding to the k-th Fourier coefficient and to the n-th electrode is then:

$${\tilde{D}}_{n}^{m} = \frac{sin ( {Φ}_{n , l} ( k ) )}{\vert sin ( {Φ}_{n , l} ( k ) ) \vert} {D}_{n}^{m} . \qquad [ Math 20 ]$$

In the second case, wrap-around effects prevent estimation of the sign of Dₙ^{k}. A sign matrix Σ is then introduced to allocate an arbitrary sign to the data.

The sign matrix Σ is estimated based on the sign of the excitation signal at t=0 for a given harmonic at a given electrode, by introducing the sign function:

$${\sum }_{n , m} = \{ \begin{matrix}1 & if {V}_{n}^{meas} > 0 , \\ 0 & if {V}_{n}^{meas} = 0 , \\ - 1 & if {V}_{n}^{meas} < 0 ,\end{matrix} \qquad [ Math 21 ]$$

with Vₙ^{meas} such as defined above.

The sign matrix Σ is more particularly defined so that its rows represent the signs of a cosine function in alternation with those of a sine function having an integer number of periods on each row. The first two rows have a single period and the number of periods increases by one for each pair of subsequent rows.

In other words, if excitation form [Math 2] is employed, the rows of the sign matrix Σ are defined such that the i-th element of the j-th row is the sign of cosine ([2π/([j+1]/2)]*(I−1)/nₑ) for odd j and sine ([2π/(j/2)]*(i−1)/nₑ) for even j.

For example, the first element of the first row of the sign matrix is the sign of cosine(0), i.e. +. For a number of electrodes nₑ equal to 16, the sign of the fifth element of the first row is the sign of cosine (2π*[4/16]), i.e. 0.

Thus, the first row of the sign matrix represents the signs of one period of a cosine function, i.e. the signs of cosine (2π*(i−1)/nₑ) for the i-th element in the row. The second row represents the signs of one period of a sine function, i.e. the signs of sine (2π*(i−1)/nₑ). The third row represents the signs of two periods of a cosine function, i.e. the signs of cosine ([2π/2]*(i−1)/nₑ). The fourth row represents the signs of two periods of a sine function, i.e. the signs of sine ([2π/2]*(i−1)/nₑ). The fifth row represents the signs of three periods of a cosine function, i.e. the signs of cosine ([2π/3]*(i−1)/nₑ), and so on until the (nₑ−1)-th row.

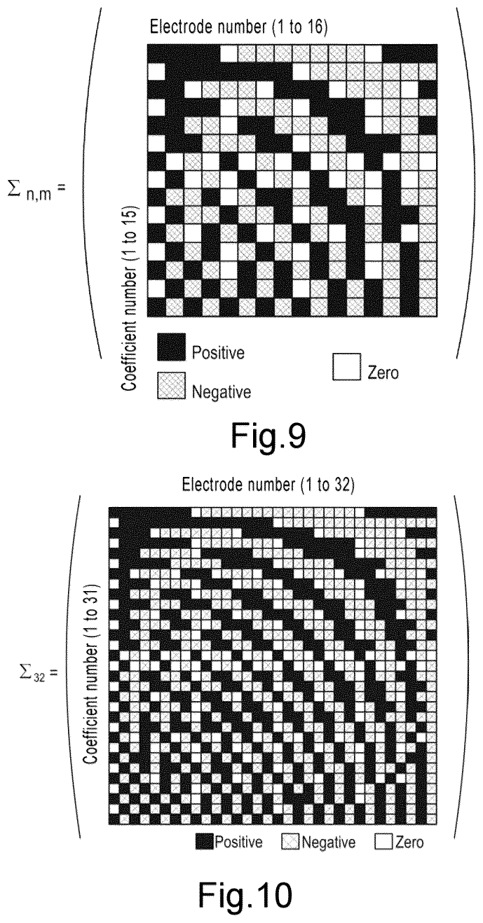

For example, for a device with 16 electrodes, the sign matrix takes the form shown in FIG. 9. For a device with 32 electrodes, the sign matrix takes the form illustrated in FIG. 10.

If excitation form [Math 5] is employed, the opposite sign is assigned to the nearest excitation electrode, in particular for a measurement electrode located equidistant between two excitation electrodes. The amplitude is experimentally measured to be of the order of O(10−7) A, corresponding to a negligible contribution to the data.

Use of such a sign matrix makes it possible to optimize the processing of the data to form an image. It allows the sign of each data point to be estimated and an image to be reconstructed.

For a large phase shift, i.e. larger than or equal to π/2, the arbitrarily signed amplitudes of the nₑ−1 excitation patterns of the nₑ electrodes, or in other words the elements of the signed data matrix corresponding to the k-th Fourier coefficient and to the n-th electrode, are given by:

$${\tilde{D}}_{n}^{m} = {\sum }_{n}^{m} {D}_{n}^{m} . \qquad [ Math 22 ]$$

### Algorithmic Implementation

The HOST portion of the acquiring system continuously sends the frequency and amplitude parameters to the FPGA of the acquiring system.

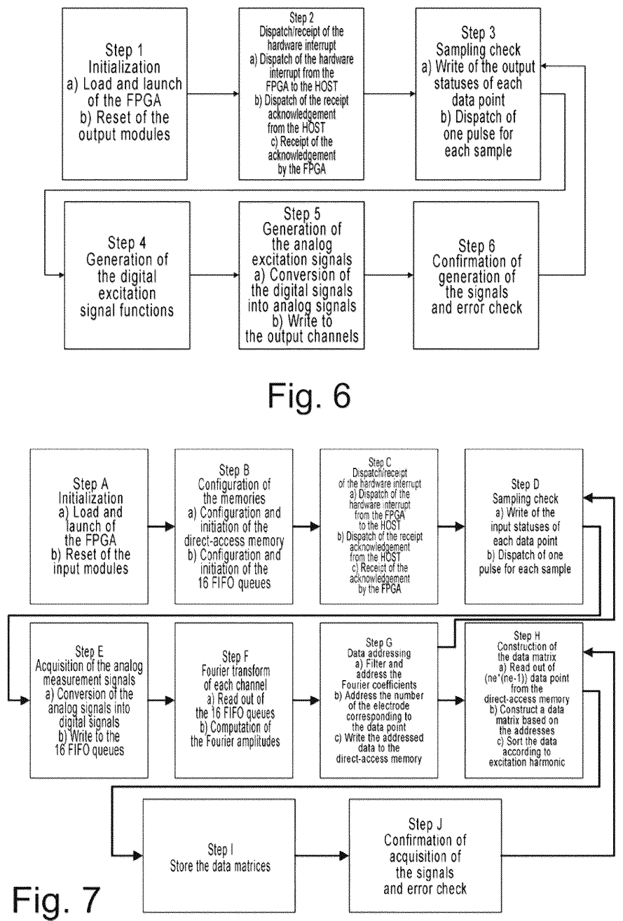

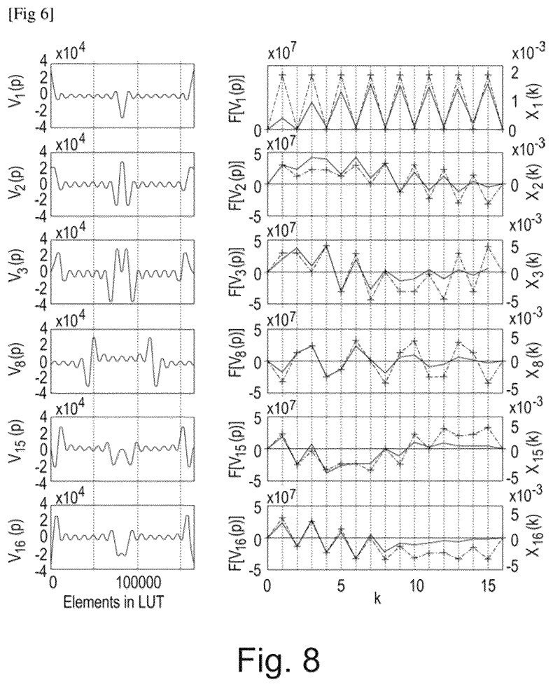

FIG. 6 illustrates an algorithm for generating the excitation signals of the 16 electrodes.

With the system in question, the FPGA receives data points 16 by 16 in a loop clocked at 1 MS/s to create 16 analog signals.

In a first step, the system is initialized.

To start with, the FPGA is empty. The HOST loads the FPGA, then the NI-9262 modules are reset.

In a second step, an interrupt request is sent and received.

A hardware interrupt is used to notify the HOST when the FPGA is ready to begin data acquisition. The FPGA waits for HOST validation to begin acquisition.

In a third step, the sampling is checked.

A sample-pulse generation function is called to begin generating data points. The frequency at which the function is called determines the sampling rate used to generate the data points. In parallel, an I/O status write function is called at the same frequency to check the status of each generated sample.

In a fourth step, digital excitation signal functions are generated.

The HOST commands the FPGA to begin generating the excitation signal functions.

In a fifth step, analog excitation signals are generated. The sixteen excitation signals are sent to the electrodes.

In a sixth step, the HOST confirms the generation of the signals and reports any errors at the HOST or FPGA level.

Steps 1 and 2 are performed once, when the algorithm is launched. Steps 3 to 6 are iterated for each output point, at the sampling frequency.

The sampling frequency may be comprised between 10 kHz and 500 MHz, and preferably between 500 kHz and 50 MHz.

FIG. 7 shows an algorithm for processing data received from the electrodes 100.

Measurement of the voltages across the terminals of the resistors R allows the Neumann boundary conditions to use in the implementation of the image reconstruction algorithm to be deduced. The acquisition rate of 1 MS/s on 16 channels corresponds to a data transfer rate of 320 MB/s.

Using fast Fourier transforms while only considering Fourier coefficients related to a generated signal allows the size of the data to be reduced without impacting their quality. It also acts as an effective band-pass filter. However, the real-time computation of 16 fast Fourier transforms requires a high computing capacity. The FPGA, which permits real-time and parallel transformation of signals into their Fourier components on a plurality of channels, is a tool suitable for carrying out this task.

In a first step A, the system is initialized.

The FPGA resets the NI-9223 analog-signal-acquiring modules.

In a second step B, the memories are configured.

The HOST configures and initiates direct access to the memory of the FPGA. The FPGA configures and initiates sixteen first-in-first-out queues to ensure communication between the sixteen measurement channels and their fast-Fourier-transform computations.

In a third step C, an interrupt request is sent and received.

A hardware interrupt makes it possible to ensure that the queues and direct memory access are ready.

In a fourth step D, the sampling is checked.

A sample pulse generation function is called to control the sampling frequency and an I/O status read function is called at the same frequency to check the status of each sample and report any errors to the HOST.

In a fifth step E, the analog measurement signals are acquired.

The I/O read function is configured to read out a single sample from each channel of each NI-9223 module. This function is called at 1 MHz and regulated by the sample pulse generation function.

In a sixth step F, the fast Fourier transform of each channel is computed in a 1 MHz loop. The computation time is determined by the number P of points considered for the Fourier transform. Once the P measured data points have been transferred for the Fourier-transform computations, the function returns the P Fourier coefficients one by one in each iteration of the Fourier-transform loop. Subsequently, the amplitudes of the Fourier coefficients are computed at a frequency of 1 MHz.

In a seventh step G, the data are addressed.

The amplitude data points in U32 format form, with the corresponding Fourier coefficient (in U16 format) and the corresponding channel (in U16 format), a data element in U64 format. In each iteration of the Fourier transform loop, 16 elements are written for the 16 channels to the direct-access memory, with a view to being transmitted to the HOST.

In an eighth step H, the data matrix is constructed.

The HOST waits for the direct-access memory to collect at least 240 elements, representing a complete data image. The address of the n-th electrode and the Fourier coefficient associated with the amplitude are used to form the data matrix D.

In a ninth step I, the data matrices are stored.

The data are used to perform real-time image reconstruction or are stored. The image is based on a one-step iterative least-squares reconstruction algorithm, for example the algorithm described in publication [5].

The real-time image reconstruction may generate of the order of one hundred images per second.

In a tenth step J, acquisition of the signals is confirmed and an error check is carried out.

Synchronization of the analog-signal-generating and -measuring modules is checked and any errors are reported.

Steps A to C are performed once, when the algorithm is launched.

Steps D to G are iterated for each output point, at the sampling frequency.

Once a complete data matrix containing nₑ*(nₑ−1) data points has been acquired, the algorithm passes to step H. Steps H to J are iterated at the image-acquisition frequency.

The sampling frequency may be comprised between 10 kHz and 500 MHz, and preferably between 500 kHz and 50 MHz.

FIG. 8 shows, in the graphs of the left-hand side, the excitation signals of six of the sixteen electrodes. Each signal is made up of a sum of 15 sinusoidal functions.

The continuous lines of the graphs on the right-hand side of FIG. 8 represent, in the equivalent Fourier space, the amplitudes of the voltages V^{meas} measured across the resistors R shown in FIG. 2, with R=200Ω. The dash-dotted lines represent the Fourier transforms of the voltages of the generated signals.

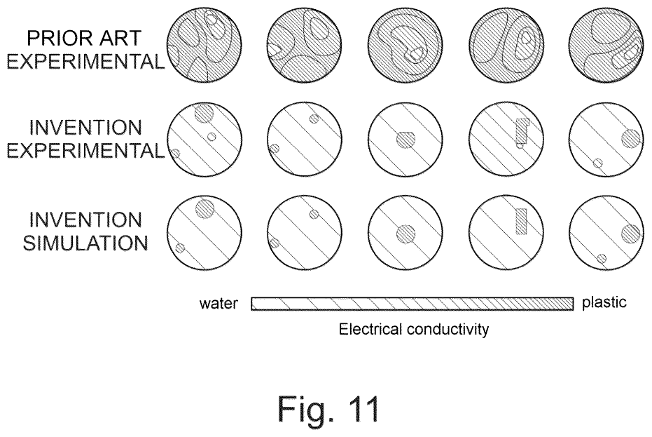

FIG. 11 illustrates experimental images obtained using a neural network to reconstruct, based on the aforementioned measurement matrices, a water flow comprising plastic foreign bodies, according to the invention and, by way of comparison, experimental images according to the prior art. It may be seen that detection according to the invention is much more accurate than detection according to the prior art and corresponds almost perfectly to the experimental situation.

Depending on signals received from the flowing fluid representative of one or more defects, the electronic automatic control unit 14 modifies or does not modify the operating frequency of the pump 20 or even stops it, so as to prevent any failure or breakage of the latter.

The invention is not limited to the examples that have just been described; it is in particular possible to combine features of the illustrated examples with one another in variants that have not been illustrated.

Other variants and improvements may be envisioned without however departing from the scope of the invention. In particular, the method implemented by the system according to the invention may use acquiring systems other than the one described.

Although illustrated in the case where the defect was a foreign body suspended in a fluid, the system according to the invention is able to detect any type of defect, and in particular a risk of pump breakage as a result of cavitation due to a lack of fluid.

Although, in the illustrated example, the number of sensor electrodes was equal to 16 or 32, a smaller number, in particular 4 or 12 electrodes, or a number larger than 32 may be envisioned.

### LIST OF CITED REFERENCES

[1] Teague, G. (2002). Mass flow measurement of multi-phase mixtures by means of tomographic techniques. University of Cape Town, Faculty of Engineering, Department of Electrical Engineering.
[2] Dupré, A., Mylvaganam, S. (2017). Simultaneous and Continuous Excitation Strategy for High Speed EIT: the ONE-SHOT method. In Proceedings of the 9th World Congress on Industrial Process Tomography, pages 667-674.
[3] Darnajou, M., Dupré, A., Dang, C., Ricciardi, G., Bourennane, S., Bellis, C. (2019). On the implementation of simultaneous multi-frequency excitations and measurements for electrical impedance tomography. Sensors, 19 (17).
[4] Darnajou, M., Dupré, A., Dang, C., Ricciardi, G., Bourennane, S., Bellis, C., Mylvaganam, S. (2020). High Speed EIT with Multifrequency Excitation using FPGA and Response Analysis using FDM. IEEE Sensors.
[5] https://www.math.colostate.edu/~siamcsu/files/NOSER.pdf

1. A system for detecting at least one defect liable to be present in a fluid flowing through a fluidic circuit comprising at least one fluidic device and, where appropriate, at least one fluidic bifurcation upstream of the fluidic device, and for preventing failure of the fluidic device inherent to the one or more defects, comprising:
at least one electrical sensor comprising a plurality of electrodes distributed around a section of the fluidic circuit upstream of the fluidic device, with their ends flush with the internal surface of the section;
an electronic circuit for controlling the electrodes and for taking electrical-impedance-tomography measurements, the circuit being configured to excite respective electrodes simultaneously, and to measure electrical impedance matrices of the fluid flowing through the section;
a signal-processing unit, configured to identify the one or more defects and/or to reconstruct images of the fluid flowing through the section, based on the measurements of impedance matrices of the electronic circuit;
an electronic unit for automatically controlling a controller of the fluidic device or the fluidic device itself or where appropriate the fluidic bifurcation, configured to modify the frequency of operation of the fluidic device or control its operation or interrupt its operation so as to prevent failure of the fluidic device or to physically extract one or more defects upstream of the fluidic device, depending on signals of the flowing fluid representative of one or more defects.

2. The detecting and preventing system as claimed in claim 1, wherein the fluidic device is a pump or a turbine, the controller being a variable frequency drive.

3. The detecting and preventing system as claimed in claim 1, wherein operation of the electronic unit for automatically controlling the fluidic device is subjugated to operation of the signal-processing unit.

4. The detecting and preventing system as claimed in claim 1, comprising a module to be arranged in the fluidic circuit, upstream of the fluidic device, the module comprising:
a duct defining the fluidic section,
a casing fastened around the duct, housing the electrical sensor with the electrodes individually housed and fastened in a seal-tight manner in a through-hole of the duct.

5. The detecting and preventing system as claimed in claim 4, wherein the casing houses a port for supplying electrical power to the electrodes.

6. The detecting and preventing system as claimed in claim 4, wherein the duct comprises, at least at one of its ends, a flange for fastening to a duct of the fluidic circuit.

7. The detecting and preventing system as claimed in claim 1, wherein the signal-processing unit is configured to implement an image-reconstructing neural network.

8. The detecting and preventing system as claimed in claim 1, wherein the control circuit is configured to implement the following steps:
a/exciting the electrodes, each electrode being excited by a potential Vₙ^{exc} having either the form:
$${V}_{n}^{exc} ( t ) \approx A {\sum }_{m = 1}^{{n}_{e}} cos ( 2 π {f}_{m} t ) [ {δ}_{m}^{𝕆} cos ( m {θ}_{n} ) + {δ}_{m}^{𝔼} sin ( \frac{m {θ}_{n}}{2} ) ] \qquad [ Math 2 ]$$
where A is a signal amplitude, m∈1, . . . , (nₑ−1) represents the spatial frequency, nₑ is the number of electrodes, θₙ is the angular position of electrode n, fₘ=m*f₀ is an oscillation frequency, f₀ is a fundamental frequency chosen such that fₘ is lower than the Nyquist frequency of the system for any m, [symbol] is the set of all odd natural numbers and [symbol] is the set of all even natural numbers,
or the form:
$${V}_{n}^{exc} ( t ) = - {\sum }_{j = 1}^{n 1} {[ {V}_{j} ( t ) ]}_{n - 1} + {\sum }_{l = {l}_{n}^{min}}^{{l}_{n}^{max}} {Ψ}_{l} ( t ) , \qquad [ Math 5 ]$$
in which, by convention, a sum is identically zero if the value of the start index is greater than the value of the end index,
where:
$${Ψ}_{i} ( t ) = A sin ( 2 π {f}_{i} t ) , \qquad [ Math 6 ]$$
$${l}_{n}^{min} = ( n - 1 ) {n}_{e} - \frac{n ( n - 1 )}{2} + 1 , and \qquad [ Math 7 ]$$
$${l}_{n}^{max} = n {n}_{e} - \frac{( n + 1 ) n}{2} , \qquad [ Math 8 ]$$
and where [Vⱼ(t)]ₙ₋₁ designates the (n−1)th element of the identity defining the voltage Vⱼ(t), under the convention according to which the terms ψᵢ are always arranged in increasing order of the indices i in such an identity, the excitation being carried out either simultaneously on all the electrodes according to [Math 5] or sequentially on one or more sub-sets of electrodes;
b/measuring the electrical properties Vₙ^{meas} of flow of the fluid with the electrodes,
c/processing the data generated in measuring step b/, this comprising the following sub-steps:
c1/for each electrode Eₙ, computing data points Mₙ defined by:
$${M}_{n} ( k ) = \frac{1}{RP} \vert {\sum }_{p = 0}^{P - 1} {V}_{n}^{meas} ( p ) {e}^{ik {β}_{p}} \vert \qquad [ Math 10 ]$$
where R is the resistance of the resistor used to measure Vₙ^{meas} with
$${V}_{n}^{meas} = R {I}_{n}$$
across the terminals of the resistor, P is the number of points in a discrete sequence of measurements of the current Iₙ, p is the discrete time, k is a Fourier coefficient between 1 and (nₑ−1) and βₚ=(2πp/P),
c2/forming a data matrix D from the data points Mₙ(k) for all n and all k, according to the equation:
$$D = ( \begin{matrix}\{ {M}_{n} ( 1 ) \} \\ \{ {M}_{n} ( 2 ) \} \\ \{ {M}_{n} ( 3 ) \} \\ ⋮ \\ \{ {M}_{n} ( {n}_{e} - 1 ) \}\end{matrix} ) . \qquad [ Math 13 ]$$
if excitation form [Math 2] is employed,
or
$$D = ( \begin{matrix}\{ {M}_{n} ( 1 ) \} \\ \{ {M}_{n} ( 2 ) \} \\ \{ {M}_{n} ( 3 ) \} \\ ⋮ \\ \{ {M}_{n} ( \frac{{n}_{e} ( {n}_{e} - 1 )}{2} ) \}\end{matrix} ) , \qquad [ Math 14 ]$$
if excitation form [Math 5] is employed,
c3/forming a signed data matrix the elements of which are defined by the following equation when the phase shift Φ_{n,1}(k) between the excitation potential of electrode 1 and the measured current of electrode n is less than π/2:
$${\tilde{D}}_{n}^{m} = \frac{sin ( {Φ}_{n , l} ( k ) )}{\vert sin ( {Φ}_{n , l} ( k ) ) \vert} {D}_{n}^{m} , \qquad [ Math 20 ]$$
and the elements of which are defined by the following equation when the phase shift Φ_{n,1}(k) between the excitation potential of electrode 1 and the measured current of electrode n is greater than or equal to π/2:
$${\tilde{D}}_{n}^{m} = {\sum }_{n}^{m} {D}_{n}^{m} . \qquad [ Math 22 ]$$
where Σ is a sign matrix defined such that:
if excitation form [Math 2] is employed, the i-th element of the j-th row of Σ is the sign of cos([2π/([j+1]/2)]*(i−1)/nₑ) for odd j and the sign of sine([2π/(j/2)]*(i−1)/nₑ) for even j,
if excitation form [Math 5] is employed, the opposite sign is assigned to the nearest excitation electrode, in particular for a measurement electrode located equidistant between two excitation electrodes, the amplitude is experimentally measured to be of the order of O(10−7) A, corresponding to a negligible contribution to the data.

9. The detecting and preventing system as claimed in claim 8, wherein the control circuit is configured to implement step a/with all of the potentials Vₙ^{exc} meeting the condition:
$${\sum }_{n = 1}^{{n}_{e}} {V}_{n}^{exc} ( t ) = 0. \qquad [ Math 4 ]$$

10. The detecting and preventing system as claimed in claim 1, wherein the electrodes of the electrical sensor are regularly angularly distributed around the section of the fluidic circuit upstream of the pump.

11. The use of the detecting and preventing system as claimed in claim 1 to measure foreign bodies and/or to measure jams, clogging and/or fouling induced by the foreign bodies, cavitation, air bubbles, the absence of fluid and the presence of gas.

12. An industrial plant comprising at least a fluidic circuit and a detecting and preventing system as claimed in claim 1.
